(19) United States
(12) Patent Application Publication
(10) Pub. No.: US 2013/0162611 A1
(43) Pub. Date: Jun. 27, 2013

(54) APPARATUS AND METHOD FOR CONTROLLING SCREEN BRIGHTNESS IN A MOBILE TERMINAL

(71) Applicant: Samsung Electronics Co., Ltd., Gyeonggi-do (KR)

(72) Inventors: Eo-Jin LIM, Gyeonggi-do (KR); Sung-Hwan BAEK, Gyeonggi-do (KR)

(73) Assignee: SAMSUNG ELECTRONICS CO., LTD., Gyeonggi-do (KR)

(21) Appl. No.: 13/721,414

(22) Filed: Dec. 20, 2012

(30) Foreign Application Priority Data
Dec. 21, 2011 (KR) 10-2011-0139240

(51) Int. Cl. G09G 5/10

(52) U.S. Cl. CPC G09G 5/10
USPC 345/207

(57) ABSTRACT

An apparatus and a method for controlling screen brightness in a mobile terminal are provided. Particularly, an apparatus and a method for providing information regarding a currently set screen brightness degree and simplifying a process for changing a brightness control mode in a mobile terminal are provided. A sensing unit of the terminal determines an amount of ambient light during an automatic brightness control mode that controls the screen brightness, and a screen manager controls the screen brightness according to either a user mode or an automatic mode where the transition from the automatic mode to the user mode is simplified.

### CLAIM OF PRIORITY

This application claims the benefit under 35 U.S.C. §119(a) of a Korean patent application filed in the Korean Intellectual Property Office on Dec. 21, 2011 and assigned Serial No. 10-2011-0139240, the entire disclosure of which is hereby incorporated by reference.

### BACKGROUND OF THE INVENTION

1. Field of the Invention

The present invention relates to an apparatus and a method for controlling screen brightness in a mobile terminal.

2. Description of the Related Art

In recent years, mobile terminals have become a necessity in the everyday life of many people. The functionality of modern mobile terminals has expanded to various fields including gaming, satellite broadcastings, and image capturing using a mounted digital camera, etc.

Generally, a mobile terminal provides information regarding each function using an output unit, such as a Liquid Crystal Display (LCD) which controls the brightness using a backlight.

However, an LCD which uses a backlight as a light source which has a drawback in that it influences visibility as the mobile terminal is frequently used outside. When brightness in the surrounding is brighter than the brightness of a display unit of the mobile terminal, visibility falls down in direct sunlight. To solve this problem, the mobile terminal provides an automatic brightness control mode that controls the brightness of the backlight depending on an amount of ambient light using an illuminance sensor. This is to automatically control screen brightness depending on an amount of ambient light via an illuminance sensor. In a dark surrounding, the brightness of the backlight is darkened to set an output screen of the mobile terminal darker. In a bright surrounding, the brightness of the backlight is brightened to set the output screen of the mobile terminal brighter, so that visibility is raised.

However, the following problem occurs when screen brightness is set in the conventional mobile terminal.

First, in the case where the mobile user desires to enter a user brightness set mode during an automatic brightness control mode, the user has to manually inactivate the automatic brightness control function.

In addition, in the case where the mobile user enters the user brightness set mode during the automatic brightness control mode, the position of a brightness control bar moves to a position regarding a default set value, so that the user must change the control bar again to a position of brightness which the user desires to control.

Moreover, the conventional mobile terminal does not provide information regarding current brightness to the user, so that the user cannot recognize a degree of the brightness of a currently set screen or a degree of changed screen brightness.

Furthermore, the conventional mobile terminal controls screen brightness using factory setting preset by a manufacturer during the automatic screen brightness control. This means that a circumstance where a brightness range that changes depending on ambient light may be different depending on a special use environment or a particular user's brightness preference is not addressed.

Therefore, an apparatus and a method of a mobile terminal for improving a user's satisfaction in providing a screen brightness control are required.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for improving a screen brightness control performance of a mobile terminal.

Another aspect of the present invention is to provide an apparatus and a method for providing information regarding a currently set screen brightness degree in a mobile terminal.

Still another aspect of the present invention is to provide an apparatus and a method for simplifying brightness control mode change in a mobile terminal.

In accordance with an aspect of the present invention, an apparatus for controlling screen brightness in a mobile terminal includes: a sensing unit for determining an amount of ambient light in an automatic brightness control mode that controls the screen brightness depending on the amount of ambient light, and a screen manager for controlling the screen brightness depending on the amount of ambient light and outputting a currently set screen brightness degree.

In accordance with another aspect of the present invention, a method for controlling screen brightness in a mobile terminal includes: determining an amount of ambient light in an automatic brightness control mode that controls the screen brightness depending on the amount of ambient light, controlling the screen brightness depending on the amount of ambient light, and after the controlling of the screen brightness, outputting a currently set screen brightness degree.

In accordance with still another aspect of the present invention, an electronic apparatus includes: at least one processor, a memory, and at least one module stored in the memory and configured to be executed by the at least one processor, wherein the module determines an amount of ambient light in an automatic brightness control mode that controls screen brightness depending on the amount of ambient light, controls the screen brightness depending on the amount of ambient light, and outputs a currently set screen brightness degree.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a block diagram illustrating a mobile terminal controlling screen brightness according to an exemplary embodiment of the present invention;

FIG. 2 is a flowchart illustrating a process for controlling screen brightness depending on an amount of ambient light in a mobile terminal according to an exemplary embodiment of the present invention;

FIG. 3 is a flowchart illustrating a process for setting screen brightness using controlled brightness depending on an amount of ambient light in a mobile terminal according to an exemplary embodiment of the present invention;

FIG. 4 is a flowchart illustrating a process for changing a screen brightness control mode in a mobile terminal according to an exemplary embodiment of the present invention;

FIGS. 5A, 5B, 5C, and 5D are views illustrating a process for outputting information regarding currently set screen brightness in a mobile terminal according to an exemplary embodiment of the present invention;

FIGS. 6A, 6B, and 6C are views illustrating a process for changing a screen brightness mode in a mobile terminal according to an exemplary embodiment of the present invention; and

FIGS. 7A, 7B, and 7C are views illustrating a screen brightness control mode in a mobile terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions of devices, circuits, and methods are omitted for clarity and conciseness.

Briefly, exemplary embodiments of the present invention provide an apparatus and a method for providing information regarding a currently set screen brightness degree to afford a better control of the display brightness and simplifying a process for changing a brightness control mode in order to address short comings of the conventional mobile terminal should be noted that the mobile terminal in the specification represents any portable electronic device, such as a mobile phone, a media player, a tablet computer, a handheld computer, or a Personal Digital Assistant (PDA). In addition, the mobile terminal may be an arbitrary portable electronic device including a device combining two or more functions among these devices.

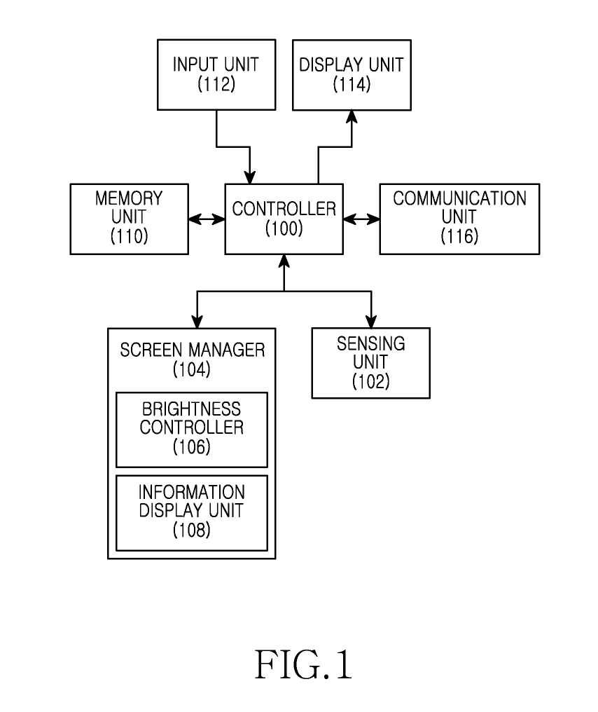

FIG. 1 is a block diagram illustrating a mobile terminal controlling screen brightness according to an exemplary embodiment of the present invention.

Referring to FIG. 1, the mobile terminal may include a controller 100, a sensing unit 102, a screen manager 104, a memory unit 110, an input unit 112, a display unit 114, and a communication unit 116. The screen manager 104 may include a brightness controller 108 and an information display unit 108.

In operation, the controller 100 of the mobile terminal controls an overall operation of the mobile terminal including voice and data communication. In addition to these general functions of the terminal, the controller 100 according to the present invention processes to simplify a mode change operation related to a screen brightness control function for users when adjusting visibility of the mobile display. To this end, when detecting a request for a brightness control by a user during an automatic brightness control mode, the controller 100 automatically releases or terminates the automatic brightness control mode to enable the user to engage in the display brightness control according to predetermined criteria.

In addition, the controller 100 processes to further provide information regarding a currently set screen brightness degree of a terminal during operation so that the user can better informed when selectively adjusting the brightness as desired. To this end, the controller 100 processes to provide a degree of the currently set screen brightness or changed screen brightness using a numerical value or a position of a brightness control bar.

The method described hereunder of the present invention may be provided as one or more instructions in one or more software modules stored in the memory 110. The software modules may be executed by the controller 100.

The sensing unit 102 determines an amount of ambient light in order to control brightness for raising visibility of the mobile terminal, and may include an illuminance sensor. Note that any light sensor which detects the brightness of various sources such as sunlight and lamps known to those skilled in the art may be implemented.

The screen manager 104 simplifies a process for changing a brightness control mode and provides information regarding a currently set screen brightness degree of the mobile terminal under control of the controller 100.

That is, the screen manager 104 automatically controls the screen brightness depending on an amount of ambient light via the brightness controller 106. In a dark environment, the screen manager 104 darkens the brightness of a backlight to set an output screen of the mobile terminal darker, and in a bright environment, the screen manager 104 lightens the brightness of the backlight to set the output screen of the mobile terminal brighter.

In addition, when detecting a request for a brightness control by a user during an automatic brightness control mode via the brightness controller 106, the screen manager 104 automatically releases or terminates the automatic brightness control mode and enters the user brightness control mode. This is done for solving a prior art problem of not entering a user brightness control mode before release the automatic brightness control mode in the general mobile terminal Thus, the screen manager 104 controls the screen brightness using a brightness range defined by the user when controlling the brightness depending on an amount of ambient light during the automatic brightness control mode via the brightness controller 106. That is, in a dark environment, the screen manager 104 darkens the brightness of a backlight using a first brightness range instead of predefined brightness range. The first brightness range is larger than predefined brightness range and vice versa.

In addition, the screen manager 104 provides a degree of currently set brightness of the screen or changed screen brightness to the user via the information display unit 108.

Furthermore, the screen manager 104 positions the position of a brightness control bar to an existing set screen brightness value when changing a brightness control mode via the information display unit 108.

The operation of the controller 100 and the screen manager 104 may be executed by a specific software module (a set of commands) stored in the memory unit 110.

The memory unit 110 includes Read Only Memory (ROM), Random Access Memory (RAM), and a flash ROM. The ROM stores microcodes of a program for processes and controls of the controller 100 and the screen manager 104, and various reference data.

The RAM serves as a working memory of the controller 100, and stores temporary data occurring during execution of various programs. In addition, the flash ROM stores various updatable data for storage such as a phonebook, calling messages, and received messages. In addition, the memory unit 110 stores a screen brightness control value (user-defined value) defined by the user.

The memory unit 106 stores a software module for performing an operation of the controller 100 and the screen manager 104.

The method executed by the screen manager 104 may be provided as one or more instructions in one or more software modules stored in the memory unit 110. In that case, the software modules may be executed by the controller unit 110.

The input unit 112 includes a plurality of function keys such as numerical key buttons of 0 to 9, a menu button, a cancel button, an OK button, a TALK button, an END button, an Internet access button, navigation key (or directional key) buttons, letter input keys, etc., and provides key input data corresponding to a key pressed by a user to the controller 100. According to an exemplary embodiment of the present invention, the input unit 112 provides a user's input data for controlling screen brightness to the controller 100.

The display unit 114 displays status information generated during an operation of the mobile terminal, characters, a large amount of moving images and still images, etc. The display unit 114 may be an LCD, an Active Matrix Organic Light-Emitting Diode (AMOLED), etc. The display unit 114 may include a touch input device, and when it is implemented as a touch input type mobile terminal, it can be used as an input means. Furthermore, according to the present invention, the display unit 114 changes its brightness depending on an amount of ambient light, and outputs information regarding currently set screen brightness or changed screen brightness.

The communication unit 116 transmits/receives a Radio Frequency (RF) signal of data input/output via an antenna (not shown). For example, during transmission, the communication unit 116 channel-codes and spreads data to be transmitted, and then performs an RF process on the signal to transmit the signal. During reception, the communication unit 116 converts a received RF signal into a baseband signal, and despreads and channel-decodes the baseband signal to recover data.

The function of the screen manager 104 may be performed by the controller 100 of the mobile terminal The separate configuration and illustration of the screen manager 104 are an exemplary purpose only for illustrative purposes, thus should not limit the scope of the present invention. It would be obvious to those skilled in the art that various other modifications may be made within the scope of the present invention.

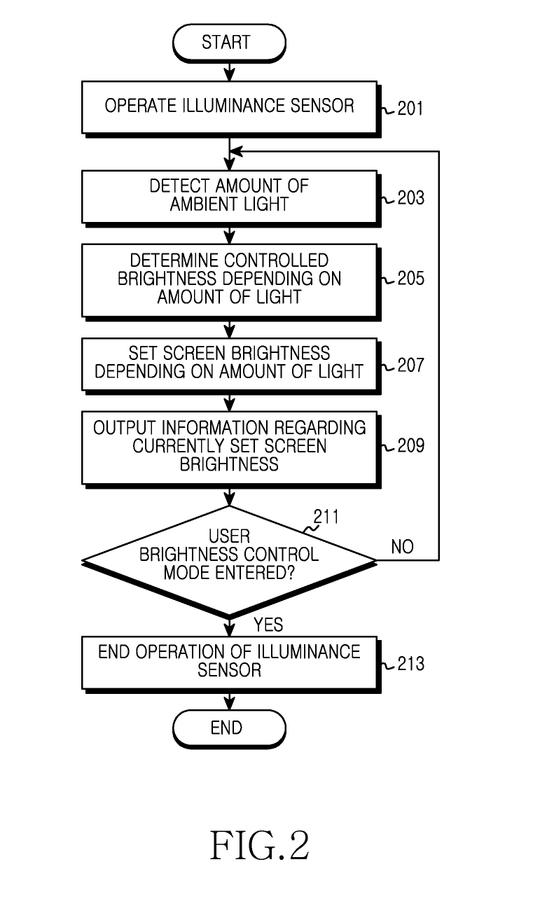

FIG. 2 is a flowchart illustrating a process for controlling screen brightness depending on an amount of ambient light in a mobile terminal according to an exemplary embodiment of the present invention.

Referring to FIG. 2, the mobile terminal operates a sensor for detecting an amount of ambient light in step 201, and detects the amount of ambient light in step 203.

The mobile terminal proceeds to step 205 to determine brightness for controlling corresponding to the detected amount of ambient light, and proceeds to step 207 to set screen brightness depending on the amount of ambient light using the controlled brightness.

Here, the brightness for controlling is a value obtained by dividing the amount of ambient light into a plurality of steps and defining a screen brightness value corresponding to each step. In step 207, the mobile terminal performs a mode of automatically controlling screen brightness to control the screen brightness.

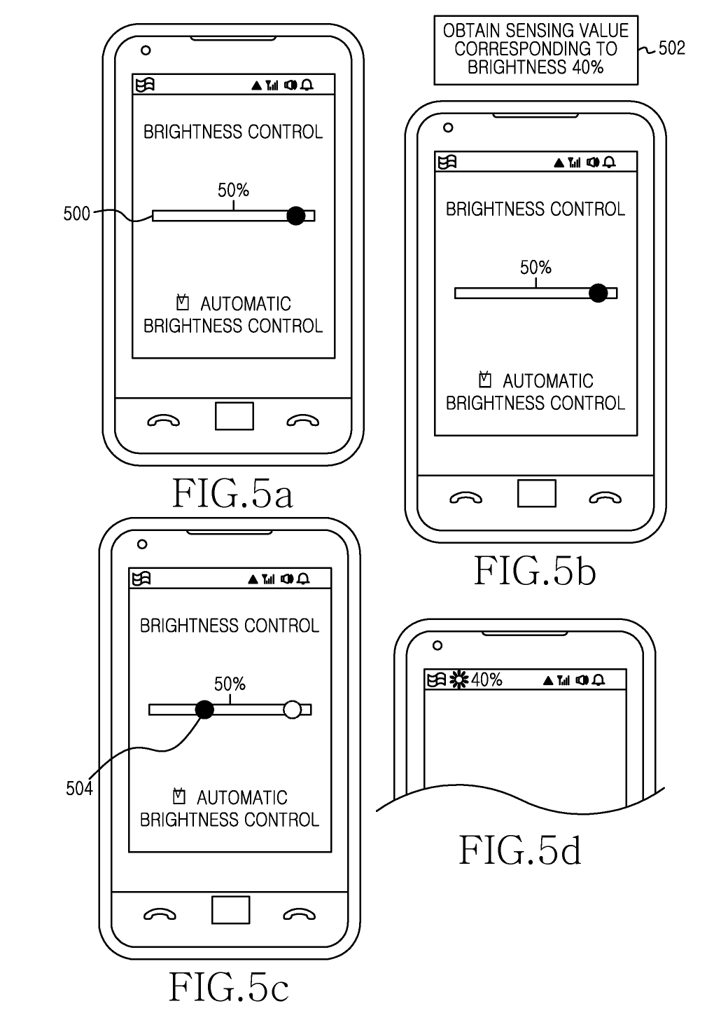

Thereafter, the mobile terminal proceeds to step 209 to process to output information regarding currently set screen brightness. Here, the mobile terminal provides a currently set screen brightness degree on an output screen. Here, The mobile terminal may change the position of a screen brightness control bar suitable for the currently set screen brightness. A further explanation will be described later with reference to FIGS. 5A, 5B, 5C, and 5D.

In addition, the mobile terminal may output a degree of currently set screen brightness on a status display window for displaying information regarding a battery residual amount, time, an antenna state, etc.

The mobile terminal proceeds to step 211 to determine whether it enters a user brightness control mode. Here, the user brightness control mode denotes a mode that allows a user to change the position of the screen brightness control bar to control the screen brightness manually regardless of an amount of ambient light. At this point, the user brightness control mode may be performed when the user changes the position of the brightness control bar or selects a menu for inactivating the automatic brightness control mode during the automatic brightness control mode state, as further explained with reference to FIGS. 5A, 5B, 5C, 5D, 6A, 6B, 6C, 7A, 7B, and 7C.

When the mobile terminal does not enter the user brightness control mode in step 211, in other words, when the mobile terminal maintains the automatic brightness control mode in step 211, the mobile terminal proceeds to step 203 to control the screen brightness according to the set automatic brightness control mode and output information regarding set screen brightness.

In contrast, when the mobile terminal enters the user brightness control mode in step 211, the mobile terminal proceeds to step 213 to terminate an operation of the illuminance sensor. This is because the mobile terminal has entered the user brightness control mode that does not use an amount of ambient light when setting screen brightness, so that the operation of the illuminance sensor does not dictate the brightness control.

After that, the mobile terminal ends the present algorithm.

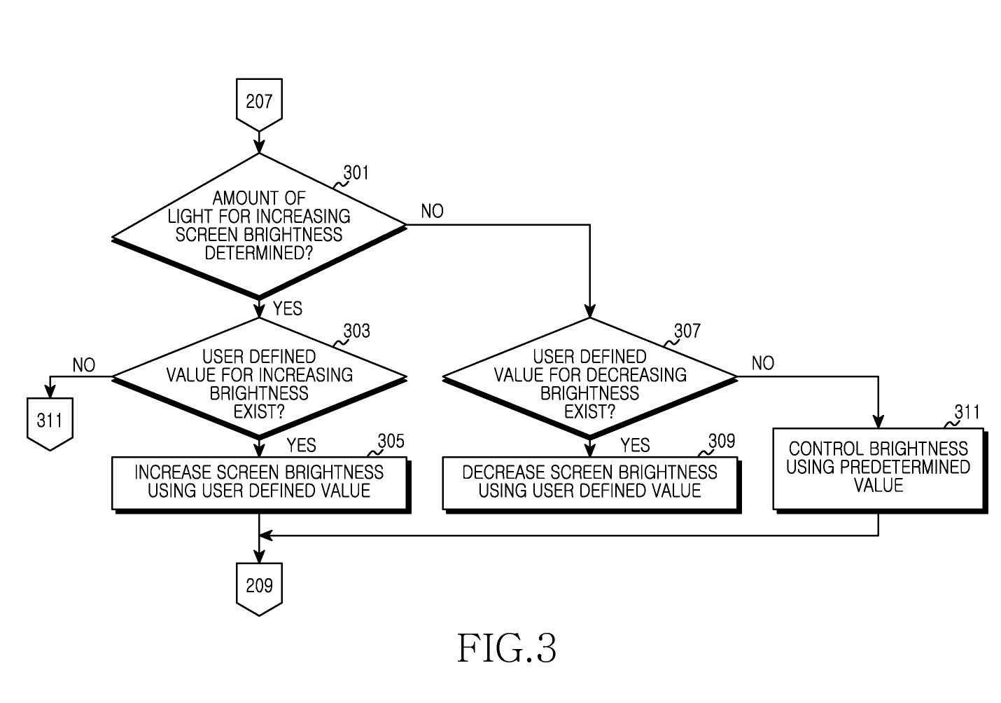

FIG. 3 is a flowchart illustrating a process for setting screen brightness using controlled brightness according to an amount of ambient light in a mobile terminal, as described in step 207 of FIG. 2, in accordance with an exemplary embodiment of the present invention.

Based on the detected amount of ambient light, the mobile terminal determines in accordance with a preset criteria whether to determine whether it detected a amount of ambient light for increasing the screen brightness in step 301.

When the amount of ambient light for increasing the screen brightness detected in step 301, the mobile terminal proceeds to step 303 to determine whether a user defined value for increasing brightness preexists. Here, the user defined value is a screen brightness control range set by a user manually depending on a special use environment or the user's own preference. In the prior art, the mobile terminal controls the screen brightness according to factory setting to control the screen brightness in a predetermined range without enabling the user to adjust as desired.

When the user defined value for increasing brightness does not preexist in step 303, the mobile terminal proceeds to step 311 to controls the screen brightness according to the automatic default set by the manufacturer.

In contrast, when the user defined value for increasing brightness preexists in step 303, the mobile terminal proceeds to step 305 to increase the screen brightness according to the user defined value (brightness control range defined by the user).

In contrast, when the amount of ambient light for decreasing the screen brightness detected in step 301, the mobile terminal proceeds to step 307 to determine whether a user defined value for decreasing brightness preexists.

If the user defined value for decreasing brightness preexists in step 307, the mobile terminal proceeds to step 309 to reduce the screen brightness if the user defined value (brightness control range defined by the user) preexists.

If the user defined value for decreasing brightness does not preexist in step 307, the mobile terminal proceeds to step 311 to adjust the screen brightness according to the factory setting.

Thereafter, the mobile terminal that has controlled the screen brightness using the user defined value or the factory setting proceeds to step 209 of FIG. 2 to output information regarding currently set screen brightness.

In an alternate embodiment, the mobile terminal may perform a process for setting a user defined value for controlling (increasing or decreasing) brightness during step 207 and then control the screen brightness using the user defined value in lieu of the default value.

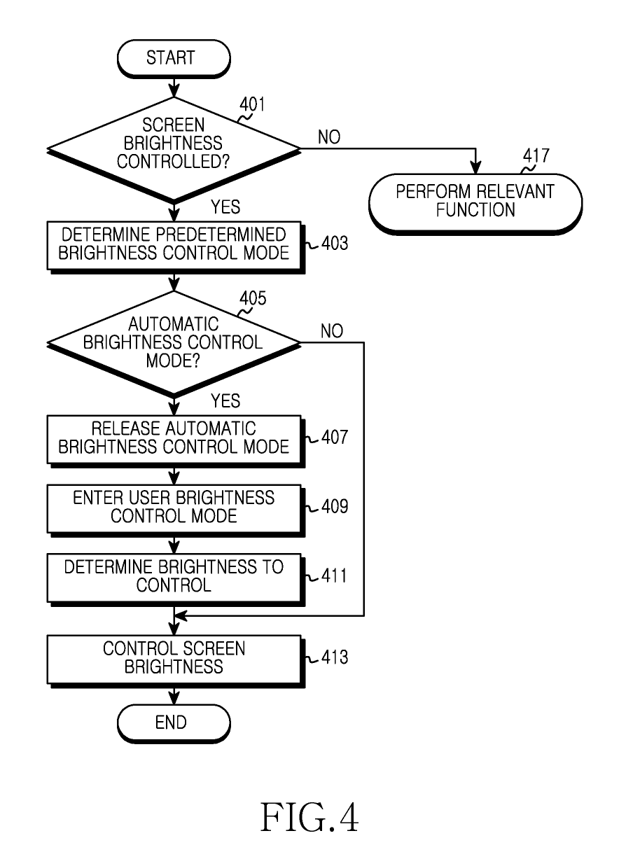

FIG. 4 is a flowchart illustrating a process for changing a screen brightness control mode, as described in step 211 of FIG. 2, in a mobile terminal according to an exemplary embodiment of the present invention.

Referring to FIG. 4, the mobile terminal determines whether a user controls screen brightness mode is entered in step 401. In the embodiment, the screen brightness control mode is triggered when the user changes the position of a screen brightness control bar to control the screen brightness manually regardless of an amount of ambient light.

When determining that the user does trigger the screen brightness control mode in step 401, the mobile terminal proceeds to step 417 to perform a relevant function (for example, standby mode).

In contrast, when determining that the user is manually controlling the screen brightness in step 401, the mobile terminal proceeds to step 403 to determine the ongoing brightness control mode. That is, the terminal may be set to an automatic brightness control mode for automatically controlling the screen brightness depending on an amount of ambient light, thus, the mobile terminal proceeds to step 405 to determine whether the terminal is currently set to the automatic brightness control mode.

If it is determined that the automatic brightness control mode in step 405, the mobile terminal proceeds to step 407 to release the current automatic brightness control mode, and then proceeds to step 409 to enter the user brightness control mode. In the prior art, the user has to manually undo the automatic brightness control mode by manipulating the menu and select the desired mode and then enter the user brightness control mode to control the screen brightness, but the mobile terminal according to the present invention automatically releases the automatic brightness control mode without the user's menu selection process by activating the control bar manually.

After that, the mobile terminal proceeds to step 411 to determine the screen brightness desired by the user.

The mobile terminal proceeds to step 413 to control the screen brightness according to the user manual manipulation on the control bar, and then ends the present algorithm.

FIGS. 5A, 5B, 5C, and 5D are views illustrating a process for outputting information regarding currently set screen brightness in a mobile terminal, as described in step 209 of FIG. 2, in accordance with an exemplary embodiment of the present invention.

Referring to FIG. 5a, the user of the mobile terminal may set the automatic brightness control mode to control screen brightness according to the detected amount of ambient light, and not according to the control of a screen brightness control bar 500. At this time, the mobile terminal to which the automatic brightness control mode has been preset obtains (502) a sensing value (an amount of ambient light) corresponding to brightness 40% via an illuminance sensor as shown in FIG. 5b, so that the mobile terminal may control the screen brightness depending on the sensing value according to a default setting.

Moreover, a user of the mobile terminal according to the present invention can release the automatic brightness control mode by manipulating the screen brightness control bar, which is set almost at maximum. That is, although the automatic brightness control mode is activated, the user can enter a user control mode by simply moving the control bar 504 while displaying it is displaying the window shown in FIGS. 5a and 5b.

Furthermore, in the prior art, the mobile terminal does not provide information regarding currently set brightness, so that the user cannot determine a degree of the screen brightness with respect to current brightness.

Accordingly, to solve this problem, the mobile terminal processes to display information regarding a sensing value obtained via the illuminance sensor on an output screen as in FIG. 5c or 5d. That is, the mobile terminal may display (504) a value corresponding to an amount of ambient light according to the position of the brightness control bar during the automatic brightness control mode as shown in FIG. 5c, or display a numeric value regarding the detected amount of ambient light on a status display window as shown in FIG. 5d.

In the prior art, the position of the brightness control bar does not change and the mobile terminal does not provide separate information regarding the screen brightness even when the mobile terminal moves to a bright place or a dark place while the automatic brightness mode is set.

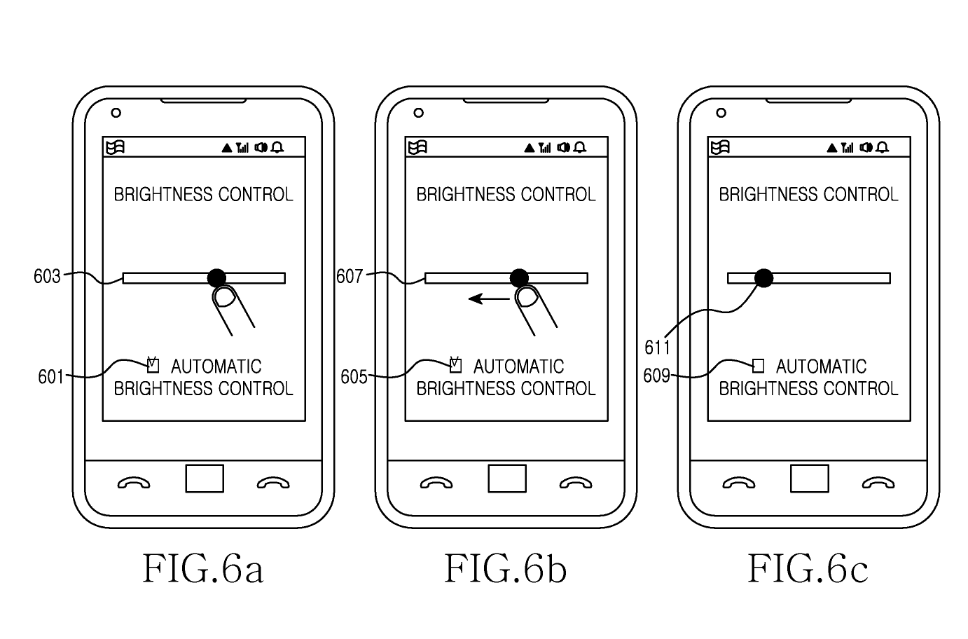

FIGS. 6A, 6B, 6C, and 6D are views illustrating a process for changing to a user screen brightness control mode from an automatic brightness control mode in a mobile terminal according to an exemplary embodiment of the present invention.

Referring to FIGS. 6A, 6B, and 6C, a mobile user can release an automatic brightness control mode by manipulating a screen brightness control bar to set screen brightness desired by the user or control the screen brightness according to the detected amount of ambient light via an automatic brightness mode.

However, in the prior art, the screen brightness control bar is inactivated during the automatic brightness mode, so that a user cannot set the screen brightness manually using the control bar.

In order to control the screen brightness, the mobile user must activates the screen brightness control bar after change from the automatic brightness control mode to user brightness control mode.

In contrast, the mobile terminal according to the present invention activates a screen brightness control bar 603 for manually controlling the screen brightness even while the automatic brightness control mode is set (601) as in FIG. 6A by merely activating the control bar manually

Accordingly, the user of the mobile terminal may change (607) the position of the screen brightness control bar during the automatic brightness control mode 605 as in FIG. 6B and in turn, the mobile terminal may release (609) the automatic brightness control mode as in FIG. 6C, and then enters a user brightness control mode to control screen brightness using the screen brightness control bar 611. Thus, the mobile user may immediately change the position of the screen brightness control bar even during the automatic brightness control mode without releasing the automatic brightness control mode manually to enter the user brightness control mode as in the prior art.

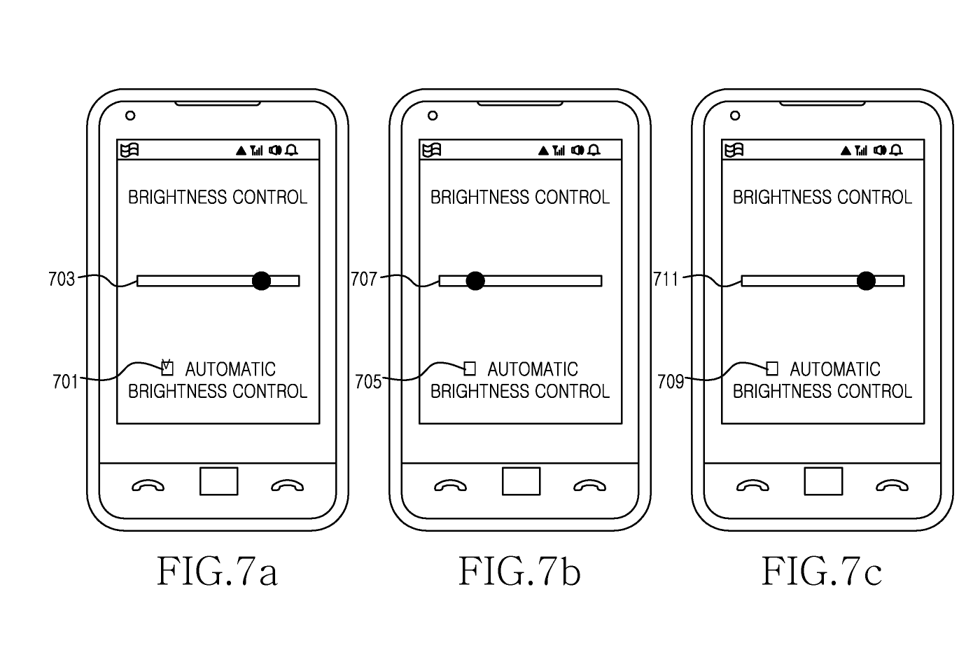

FIGS. 7A, 7B, and 7C are views illustrating a screen brightness control mode in a mobile terminal according to another exemplary embodiment of the present invention.

Referring now to FIGS. 7A through 7C7, a mobile user can release an automatic brightness control mode by undoing the selection 701 and manipulates a screen brightness control bar to set screen brightness desired by the user or control the screen brightness according to the detected amount of ambient light via the automatic brightness mode.

In operation, the user of the mobile terminal may lighten or darken current screen brightness further based on the screen brightness set during an automatic brightness control mode 701 as in FIG. 7a. At this point, the mobile user set the screen brightness control bar 703 to a particular level to enter a user brightness control mode as shown in FIG. 7a.

However, in the prior art, when the mobile terminal enters (705) a user brightness control mode from an automatic brightness mode as in FIG. 7B, the position of a screen brightness control bar moves (707) to a predetermined position regardless of current screen brightness, so that the user cannot determine screen brightness set during the automatic brightness control mode. For example, when the mobile terminal enters (705) a user brightness control mode from an automatic brightness mode, the position of a screen brightness control bar corresponding to current brightness change in to a central point of moving range.

Therefore, when the mobile terminal enters (709) the user brightness control mode from the automatic brightness mode according to the present invention as in FIG. 7C, the position of the screen brightness control bar is fixed (711) to a position corresponding to current screen brightness, so that the user may lighten or darken the current screen brightness further based on the screen brightness set.

As described above, the present invention improves a screen brightness control function in a mobile terminal, by providing information regarding a currently set screen brightness degree and simplifying a process for changing a brightness control mode, thereby improving a user's satisfaction regarding screen brightness control.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the present invention should not be limited to the above-described embodiments but should be determined by not only the appended claims but also the equivalents thereof.

What is claimed is:

1. An apparatus for controlling screen brightness in a mobile terminal, comprising:
a sensing unit for detecting an amount of ambient light during an automatic brightness control mode; and
a screen manager for controlling the screen brightness according to the detected amount of ambient light and outputting a currently set screen brightness degree indicative of the screen brightness level.

2. The apparatus of claim 1, further comprising a controller for terminating an operation of the sensor unit when the mobile terminal enters a user brightness control mode from the automatic brightness control mode.

3. The apparatus of claim 1, wherein the screen manager controls the screen brightness by increasing or decreasing using a predefined screen brightness control value.

4. The apparatus of claim 1, wherein upon detecting an input to activate the control of the screen brightness, the screen manager releases the automatic brightness control mode and then enters a user brightness control mode.

5. The apparatus of claim 4, wherein after releasing the automatic brightness control mode and entering the user brightness control mode, maintaining the currently set screen brightness degree indicative of the screen brightness level.

6. The apparatus of claim 1, wherein the screen manager outputs a screen brightness level using a position of a brightness control bar, or outputs a brightness degree on a portion of an output screen.

7. A method for controlling screen brightness in a mobile terminal, the method comprising:
detecting an amount of ambient light during an automatic brightness control mode using a sensor;
controlling the screen brightness according to the detected amount of ambient light; and
outputting a currently set screen brightness degree indicative of the screen brightness level.

8. The method of claim 7, further comprising terminating an operation of the sensor in response to switching to a user brightness control mode from the automatic brightness control mode,

9. The method of claim 7, wherein the controlling of the screen brightness comprises increasing or decreasing the screen brightness using a predefined screen brightness control value.

10. The method of claim 7, further comprising:
upon detecting an input for controlling the screen brightness during the automatic brightness control mode, releasing the automatic brightness control mode and entering a user brightness control mode.

11. The method of claim 10, wherein after releasing the automatic brightness control mode and entering the user brightness control mode, maintaining the currently set screen brightness degree indicative of the screen brightness level.

12. The method of claim 7, wherein outputting the currently set screen brightness degree comprises outputting a screen brightness level using a position of a brightness control bar, or outputting a brightness degree on a portion of an output screen.

13. A portable terminal for controlling screen brightness comprising:
a processor;
a memory, coupled to said processor, said memory being configured to allow the processor to:
detect an amount of ambient light during an automatic brightness control mode;
control the screen brightness according to the detected amount of ambient light; and
output a currently set screen brightness degree indicative of the screen brightness level.

14. The terminal of claim 13, wherein when the terminal enters a user brightness control mode from the automatic brightness control mode, terminating the detection step of the ambient light.

15. The terminal of claim 13, wherein the processor controls the screen brightness by increasing or decreasing the screen brightness using a predefined screen brightness control value.

16. The terminal of claim 13, wherein the processor, upon detecting an input for controlling the screen brightness during the automatic brightness control mode, r releases the automatic brightness control mode and then enters a user brightness control mode.

17. The terminal of claim 16, wherein after releasing the automatic brightness control mode and entering the user brightness control mode, the processor further maintains the currently set screen brightness degree indicative of the screen brightness level.

18. The terminal of claim 13, wherein the processor outputs a currently set screen brightness degree by outputting a screen brightness level using a position of a brightness control bar, or outputting a brightness degree on a portion of an output screen.
